(19) United States
(12) Patent Application Publication
(10) Pub. No.: US 2003/0113151 A1
(43) Pub. Date: Jun. 19, 2003

(54) Distribution label, a distribution label printing system, and a distribution method using the same

(76) Inventors: Kazuyuki Yokoyama, Matsumoto-shi (JP); Akihiro Goto, Matsumoto-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/292,239

(22) Filed: Nov. 12, 2002

(30) Foreign Application Priority Data
Nov. 12, 2001 (JP) 2001-346561
Nov. 12, 2001 (JP) 2001-346562

(51) Int. Cl. B41J 5/00

(52) U.S. Cl. 400/103

(57) ABSTRACT

A simplified system for printing labels used for package delivery and distribution reduces label costs and management problems, prevents delivery errors, and shortens labeling and delivery time. The distribution label has a label material on the surface of which are printed delivery information for the associated package and additional information related to the package. The additional information includes specific information printed in color for easy recognition.

### BACKGROUND OF THE INVENTION

1. Field of the Invention

The present invention relates to a distribution label for use in various distribution systems, to a distribution label printing system, and to a distribution method using the distribution label printing system.

2. Description of the Related Art

Various types of information relating to goods or packages being delivered or distributed (referred to below as the delivery or distribution goods or packages) must be managed in the package delivery and distribution industries. This information is typically printed on a label that is then attached to the package. Conventionally these labels identify the sender and addressee using text and/or a bar code. The name of the product may also be listed on such labels, but other than that, they contain little additional information about the package or package content.

Information about the delivery service applicable to a particular package, such as air special delivery, next-day delivery or standard service, is typically provided by using different color-coded labels corresponding to each particular level of service. The labels are then used and printed according to the delivery service requested by the customer. In this case the specified time of delivery and package receiving instructions are noted on the delivery ticket and a separate label is additionally applied to the package. Special handling instructions are commonly indicated on yet another separate label that is also applied to the package.

As the range of delivery options selectable by the customer has grown, the information relating to each package that must be managed has also increased. Conventional labels do not adequately present this information, leading to visual recognition errors that result in delivery mistakes.

This is a particular problem, for example, in small distribution centers and delivery truck loading docks, where it is not practical to install automated package sorting systems. Package handling therefore depends on workers correctly reading the labels. In addition, the cost of finding a missing package resulting from a delivery error is high both in monetary terms and in lost trust even if the actual probability of a package being lost is very low. This is why, in addition to the distribution label, conventional systems apply separate labels containing other information (such as the services selected by the customer and handling instructions). The problem here is that applying multiple labels to a single package can be troublesome, multiple systems are needed to print the labels, and further costs are incurred both for the labels themselves and for managing the labels.

With conventional systems, a label with printed text or bar code denoting attributes of the distribution goods (referred to as a lot sticker or lot label) is also applied separately to the package in addition to the distribution label. If the package is a gift, the package may also be given special gift wrapping. The problem here is that applying multiple labels to a single product and using special packaging further complicates shipping operations, requires plural printing systems, requires the delivery or distribution company to maintain stocks of labels in a wide range of formats according to the service content, and increases label costs and label management problems.

### OBJECTS OF THE INVENTION

The present invention is directed to solving the aforementioned problems. Accordingly, an object of the invention is to provide technology for simplifying both distribution label application and the system for label printing, and for reducing label costs and management problems.

Another object of the present invention is to provide technology making visual recognition of label content easier on the delivery route, thereby preventing delivery errors and shortening work time.

A further object of the invention is to provide technology for providing labels that can be used to offer new services to the package sender and recipient, simplifying both distribution label application for the delivery or distribution company and the printing system, and for reducing label cost and management problems.

### SUMMARY OF THE INVENTION

To achieve these objects a distribution label according to one aspect of the present invention contains a printable surface defined by a plurality of areas, including a first area having printed therein delivery information about an associated delivery package, and a second area having printed therein additional information relating to an associated delivery package, wherein the additional information comprises, at least in part, a color representation identifying at least one of: content of an associated delivery package, delivery service information of an associated delivery package, type of delivery package, or handling information relating to an associated delivery package or contents therein.

The delivery service information includes the date and/or time the package is to be delivered, delivery means instructions, or delivery priority instructions. Such information may also designate whether the package is to be delivered by air special delivery, overnight service, or standard service. The delivery date and time instructions could include the date, weekday, a specific time or time band, or combination thereof, as well as where the package is to be delivered, whether to bill the recipient or collect on delivery, or whether a signature is required for delivery. Information regarding the type of package may include information indicating a special service, e.g., that the package contains a gift for the recipient.

According to another aspect of the invention, a distribution label printing system is provided for printing information on a distribution label. The system comprises an input unit for inputting data relating to a delivery package, a data processing unit for generating delivery information and additional information relating to the delivery package based on the input data, and a color printer for printing the generated delivery information and additional information to a surface of the label. The label surface and information contained thereon is as described above with respect the distribution label aspect of the invention.

A distribution method according to another aspect of the present invention using a distribution label. The method comprises adding delivery information about a delivery package to a first area of a surface of the distribution label, adding additional information to a second area of the label surface. The additional information is as described with respect to the distribution label aspect of the invention. The method also includes applying the distribution label containing the delivery information and additional information to the delivery package.

The content, delivery service information, type, and handling information of the package to be delivered is selected from a specific table.

The information relating to delivery service content includes a user specified information relating to a delivery date or time, delivery means instruction, or delivery priority instruction for the delivery package. The handling information includes information relating to handling instructions specified based on an attribute of the delivery package.

By using a distribution label containing, in addition to delivery information, other information such as the package content, delivery date/time, handling instructions, and/or information intended for the recipient, it is not necessary to apply multiple labels to the delivery package. Label application is therefore easier, the label printing system is simplified, and the cost of the labels and problems with managing the labels are reduced. New services can also be provided for the package recipient enabling the recipient to recognize, for example, that a special package, such as a gift, was received without using special wrapping on the package. This improves customer satisfaction. Furthermore, because the additional information applied to the delivery package includes color information, the information is easier to read and recognize on the delivery route, thereby greatly reducing inadvertent delivery errors and thus shortening the work time.

The present invention thus enables building a fast distribution system substantially free of delivery errors at a low cost.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of a distribution label according to a first embodiment of the invention;

FIGS. 2(A) and 2(B) are plan views of respective distribution labels according to a second embodiment of the invention;

FIG. 3 is a plan view of a distribution label according to a third embodiment of the invention;

FIG. 4 is a block diagram of a distribution label printing system according to embodiments of the present invention;

FIG. 5 is a flow chart of a first process for printing a distribution label according to embodiments of the present invention;

FIG. 6 is a flow chart of a second process for printing a distribution label according to embodiments of the present invention; and

FIG. 7 is a flow chart of a third process for printing a distribution label according to embodiments of the present invention.

### DESCRIPTION OF THE PREFERRED EMBODIMENTS

Preferred embodiments of the present invention are described below with reference to the accompanying figures.

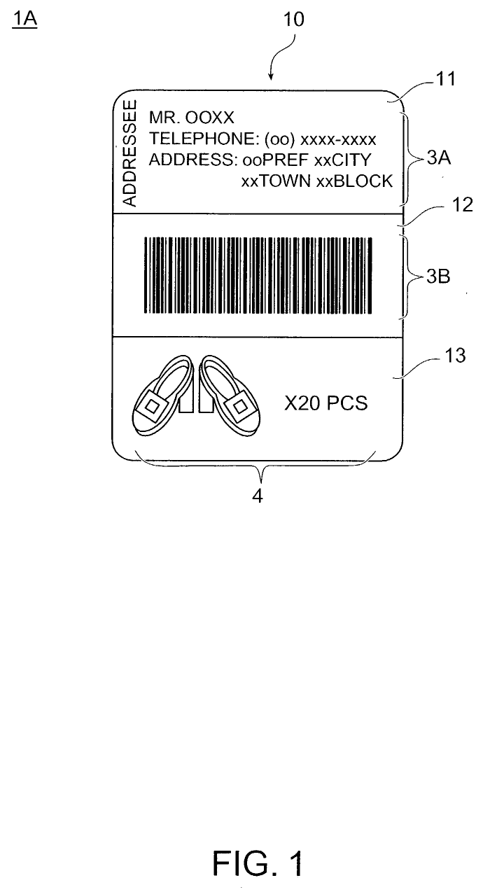

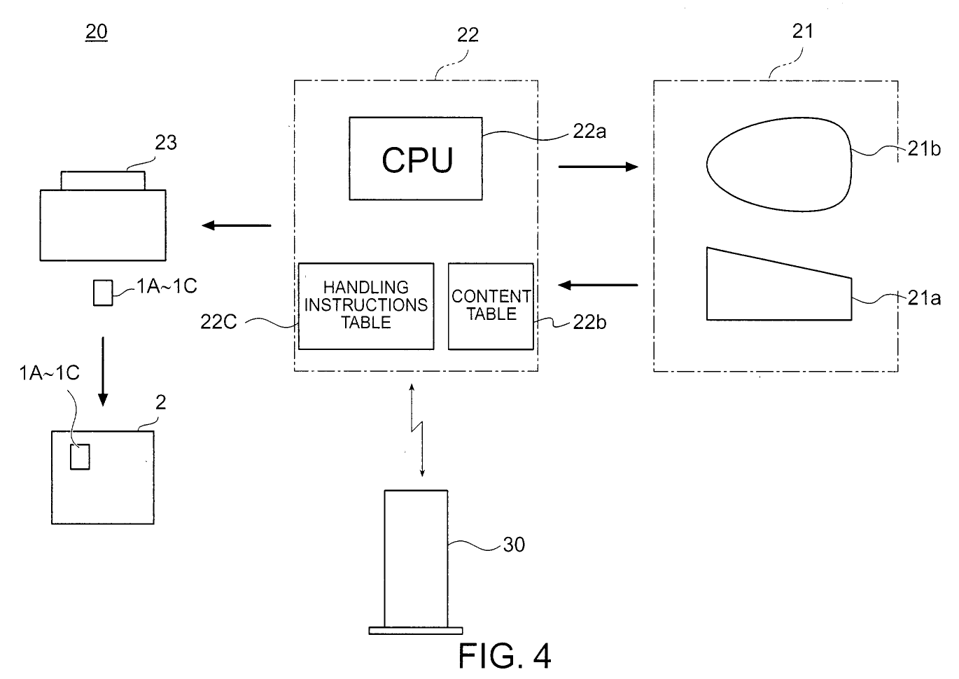

FIG. 1 is a plan view of a distribution label according to a first embodiment of the invention. As shown in FIG. 1, a distribution label 1A according to the present embodiment has a rectangular label material 10 made from a plastic film, for example, for application to the delivery package 2 (see FIG. 4). Delivery information 3A and 3B and additional information 4, further described below, are printed on the surface of the label material 10.

The surface of the label material 10 is divided into a number of areas with specific information printed in each area. In this embodiment of the invention there are three such areas. However, the number of areas may vary depending on the application.

The name, telephone number, and address of the recipient are printed as delivery information 3A in the first area 11 of the label material 10. This delivery information 3A is printed in a particular color, preferably black.

The delivery information 3B printed in the second area 12 in the middle of the label material 10 contains a bar code printed in a particular color, preferably black. The bar code contains a tracking code. It should be noted that various types of bar codes can be printed, including 2D bar code symbols containing, in addition to the tracking code, the postal code of the recipient and all other delivery information including the sender and recipient.

The additional information 4 relating to the delivery package 2 printed in the third area 13 of the label material 10 contains information denoting the content of the delivery package 2.

In the example shown in FIG. 1 this additional information 4 is a symbol and quantity information indicating that there are twenty pairs of shoes in the delivery package 2. The additional information 4 is printed in multiple colors in this embodiment of the invention.

This type of label is preferably used in so-called B2B (business-to-business) delivery services. For example, the delivery and distribution service contractor handling the work of the distribution department of the sender (e.g., the shoe manufacturer or wholesaler in the case of the label shown in FIG. 1) could use this label to improve service to the addressee (such as a shoe retailer) when making deliveries.

More specifically, the recipient could use the bar code printed in the second area 12 of the label material 10 to automatically read the information about the delivered package 2 while manually reading the symbol printed as the additional information 4 for package receipt and inventory management. Furthermore, content that can be difficult to express with text, such as shape, color, and design information, can be expressed using such symbols, thereby enabling the recipient to immediately recognize the package by simply looking at the label content without breaking the wrapping.

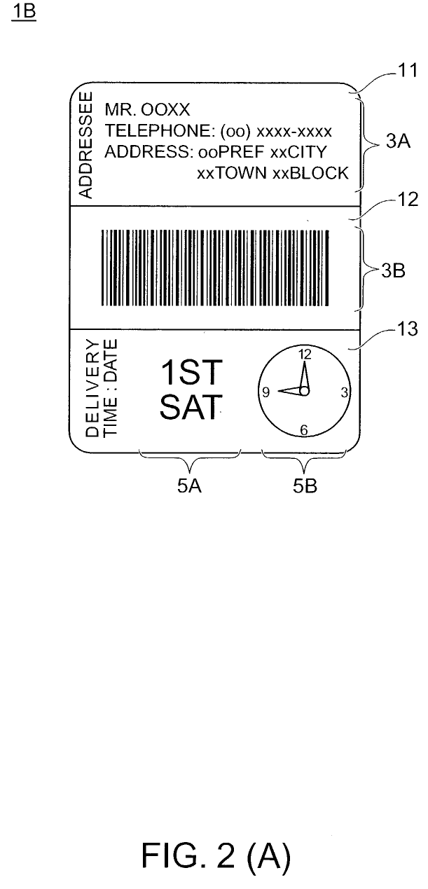

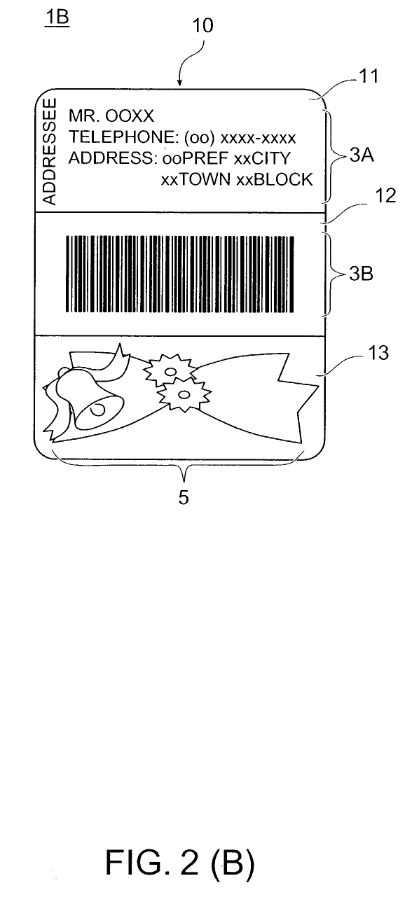

FIG. 2(A) is a plan view of a distribution label 1B according to a second embodiment of the invention. As shown in FIG. 2(A), distribution label 1B according to this embodiment also has a rectangular label material 10 made from a plastic film, for example. Delivery information 3A and 3B and additional information 5A and 5B, further described below, are printed on the surface of the label material 10.

The surface of this label material 10 is also divided into three areas with specific information printed in each area. The name, telephone number, and address of the recipient are printed in a particular color, preferably black, as delivery information 3A in the first area 11, and a particular bar code is printed in a particular color, preferably black, as delivery information 3B in the second area 12 in the middle of the label material 10.

The additional information 5A relating to the delivery package 2 printed in the third area 13 of the label material 10 in this embodiment contains delivery service content, specifically information about the package delivery date. In this example the additional information 5A, which is preferably printed in a color other than the color used for printing the delivery information in 3A and 3B shows the date (e.g., the 1^{st}) and day (e.g., Saturday) that the delivery package 2 is to be delivered.

The other additional information 5B printed in the third area 13 is a clock symbol showing the delivery time (e.g., 9:00 a.m.) This symbol is printed in multiple colors.

This additional information 5A and 5B printed in the third area 13 is not limited to the date and time of delivery. Rather, such additional information may include other information, such as the requested delivery time band (e.g., the morning), delivery method (e.g., air special delivery, next-day delivery, or standard delivery), or other special instructions, such as a designated delivery location, bill to sender, COD, or signature required designation printed in multiple colors.

FIG. 2(B) is a plan view of a distribution label 1B according to a third embodiment of the invention. As shown in FIG. 2(B), distribution label 1B according to this embodiment also has a rectangular label material 10 made from a plastic film, for example. Delivery information 3A and 3B and additional information 5, further described below, are printed on the surface of the label material 10.

The surface of this label material 10 is also divided into three areas with specific information printed in each area. The name, telephone number, and address of the recipient are printed in a particular color, preferably black, as delivery information 3A in the first area 11, and a particular bar code is printed in a particular color, preferably black, as delivery information 3B in the second area 12 in the middle of the label material 10.

The additional information 5 relating to the delivery package 2 printed in the third area 13 of the label material 10 in this embodiment is information for the package recipient, that is, information about a particular service intended for the recipient.

In this example a symbol indicating a Christmas gift is printed in multiple colors as the additional information 5. This type of label is particularly suited to so-called B2C (business-to-consumer) and C2C (consumer-to-consumer) services. A major purpose of sending a gift at special occasions such as New Years, Christmas, birthdays, and weddings is to please the recipient. Attractive wrapping paper and ribbons can be particularly effective for this purpose, but can be impractical when sending the goods by a delivery service. By using a label such as that of the present embodiment, however, the recipient knows that the delivered package contains something special (such as a gift) for the recipient even though it is not specially wrapped. As a result, the service provided to the recipient can be improved.

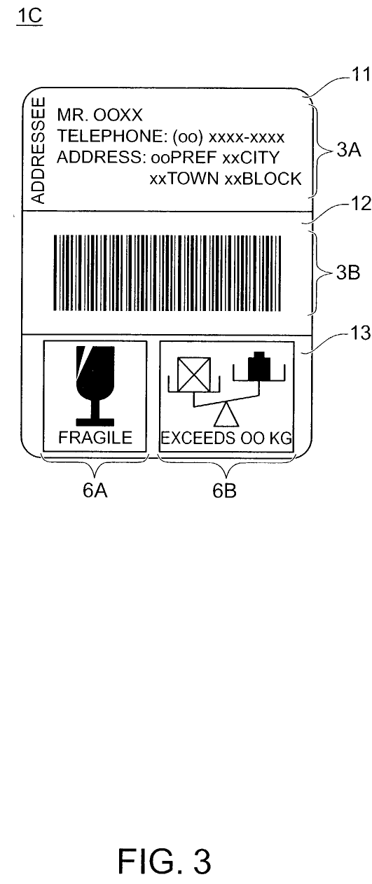

FIG. 3 is a plan view of a distribution label 1C according to a fourth embodiment of the invention. As shown in FIG. 3, distribution label 1C according to this embodiment also has a rectangular label material 10 made from a plastic film, for example. Delivery information 3A and 3B and additional information 6A and 6B, further described below, are printed on the surface of the label material 10.

The name, telephone number, and address of the recipient are printed in a particular color, preferably black, as delivery information 3A a the first area 11 of the label, and a particular bar code is printed in a particular color, preferably black, as delivery information 3B in the second area 12 in the middle of the label material 10.

The additional information 6A relating to the delivery package 2 printed in the third area 13 of the label material 10 in this embodiment contains package handling information, e.g., information indicating that the delivery package 2 is fragile. This additional information is not limited to denoting fragile goods. For example, if the delivery package 2 contains fresh food or frozen food, the additional information could denote “fresh fruit” or “keep frozen.” Additional information regarding the handling of the delivery package 2 is printed in a color other than that used to print the information 3A and 3B in this embodiment of the invention.

Other additional information 6B printed in this third area 13 denotes that the package exceeds a certain weight limit, and is printed in multiple colors.

FIG. 4 is a block diagram showing the configuration of a distribution label printing system according to the present invention. As shown in FIG. 4, this distribution label printing system 20 has an input unit 21, a data processing unit 22 in communication with the input unit 21 and with a server 30 through a network. A color printer 23 is in communication with the data processing unit 22. The color printer 23 can print in monochrome or multiple colors to the surface of the label material 10.

The input unit 21 has a keyboard or other input device 21a for inputting delivery information such as the name, telephone number, and address of the recipient, and a display 21b for displaying the input information.

The data processing unit 22 has a CPU 22a that communicates data with a ROM, RAM, or other storage device not shown in the figure, and runs specific processes using data input from input unit 21 and specific data tables 22b, 22c stored in ROM.

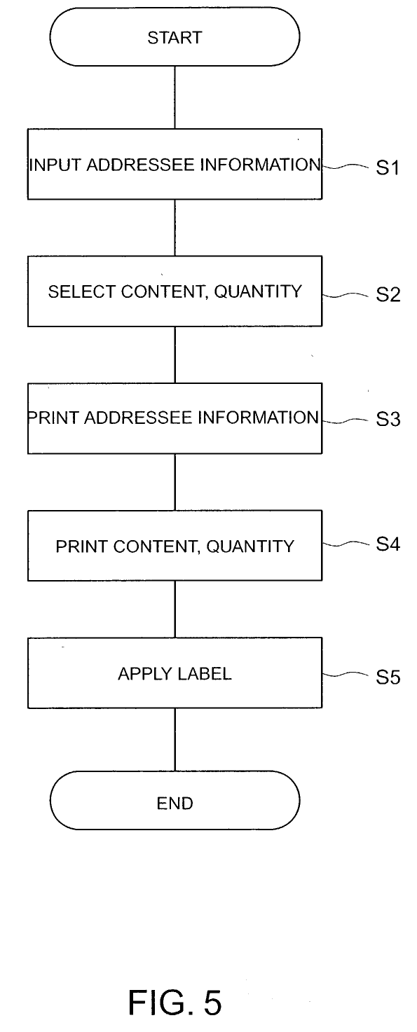

FIG. 5 to FIG. 7 are flow charts showing the major steps in the distribution method of the present invention.

FIG. 5 shows a process used when using a distribution label 1A such as that shown in FIG. 1. As shown in FIG. 5, the delivery information 3A and 3B is first input according to the sender's instructions using the operator's keyboard or other input device 21a (step S1). In this example the name, address, and telephone number of the sender is input.

The additional information 4 including specific color information relating to the delivery package 2 is then input (step S2).

In this example the operator uses the input device 21a to display on the display 21b of input unit 21 specific symbols from a data table 22b in data processing unit 22 relating to package content and then select an appropriate symbol according to the sender's instructions. The quantity of the selected content is likewise specified using the input device 21a.

The delivery information 3A and 3B defined as described above is then printed to the surface of the label material 10 by the color printer 23 (step S3).

In this example the delivery information 3A containing the name, address, and telephone number of the recipient is printed in black in the first area 11 of the label material 10 as described above. In addition, a bar code containing a tracking code is printed in black as delivery information 3B in the second area 12 of the label material 10.

Next, the additional information 4 as described above is printed on the surface of label material 10 by the color printer 23 (step S4).

In this example the additional information 4 printed on the surface of the label material 10 denotes the content of the delivery package 2. More specifically, the additional information 4 printed in the third area 13 of label material 10, as shown in FIG. 1, includes a symbol printed in color indicating the product (e.g., shoes) contained in the package and characters printed in black indicating the quantity of the product (e.g., ×20).

The distribution label 1A containing the delivery information 3A and 3B and additional information 4 is then applied to the delivery package 2 (step S5).

The delivery package 2 with attached distribution label 1A is then passed to the normal delivery channel and delivered.

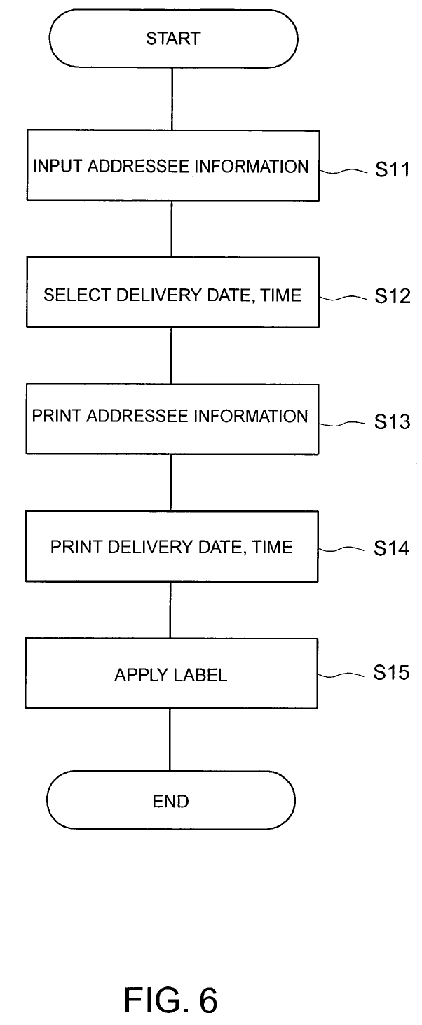

FIG. 6 shows a process used with a distribution label 1B such as shown in FIG. 2(A) or (B). As shown in FIG. 6 and described with reference to FIG. 5, the delivery information 3A and 3B is first input according to the sender's instructions using the operator's keyboard or other input device 21a (step S11).

The additional information 5A and 5B (or additional information 5 as shown in FIG. 2(B)) including specific color information relating to the delivery package 2 is then defined in step S12.

To print a label as shown in FIG. 2(A), the operator uses the input device 21a to input the package delivery date and day, and delivery time if requested, according to the sender's instructions.

To print a label as shown in FIG. 2(B), the operator uses the input device 21a to display on the display 21b of input unit 21 specific symbols from data table 22c in data processing unit 22 relating to delivery services and then select an appropriate symbol according to the sender's instructions. In this example the operator selects a symbol indicating a Christmas gift delivery using the input device 21a.

The delivery information 3A and 3B defined as described above is then printed on the surface of the label material 10 by the color printer 23 (step S13).

In this example the delivery information 3A containing the recipient information is printed in black to the first area 11 of the label material 10 as described above, and a specific bar code (delivery information 3B) is printed in black to the second area 12 of the label material 10.

Next, the additional information 5A, 5B defined as described above is printed to the surface of label material 10 by the color printer 23 (step S14).

To print a label as shown in FIG. 2(A), additional information 5A and 5B indicating the date and time of delivery are printed to the third area 13 of label material 10. More specifically, an indication (additional information 5A) of the date (e.g., the 1^{st}) and day (e.g., Saturday) the package 2 is to be delivered are printed in one color other than black on the third area 13 of the label material 10, and a clock symbol (additional information 5B) indicating the delivery time (e.g., 9:00 a.m.) is printed in multiple colors in this example.

To print a symbol as shown in FIG. 2(B), a symbol denoting a Christmas gift is printed to the third area 13 of the label material 10.

The distribution label 1B containing the delivery information 3A and 3B and additional information 5A, 5B (additional information 5 in FIG. 2(B)) is then applied to the delivery package 2 (step S15).

The delivery package 2 with attached distribution label 1B is then passed to the normal delivery channel and delivered.

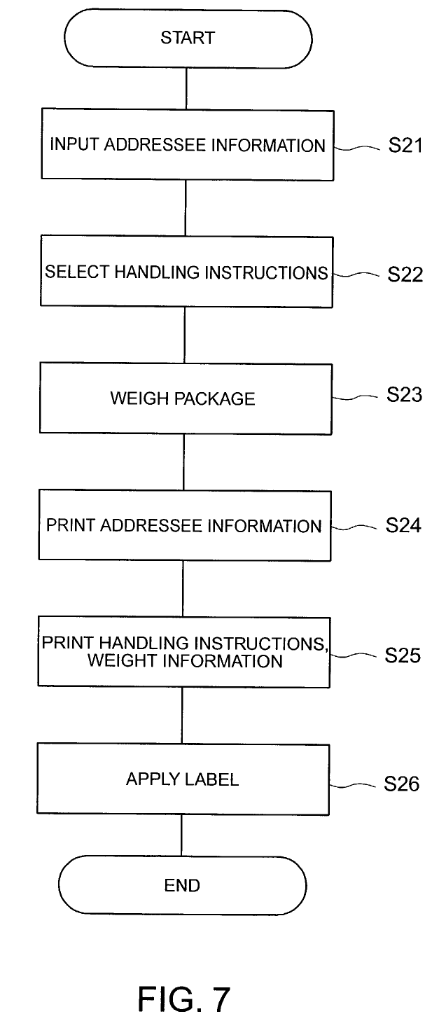

FIG. 7 shows a process used with a distribution label such as that shown in FIG. 3. As shown in FIG. 7 and described above, the delivery information 3A and 3B is first input according to the sender's instructions using the operator's keyboard or other input device 21a (step S21).

The additional information 6A including specific color information relating to the delivery package 2 is then defined (step S22).

The operator uses the input device 21a to display on the display 21b of input unit 21 specific symbols from data table 22c in data processing unit 22 relating to package handling instructions and then select an appropriate symbol according to the sender's instructions. In this example a symbol indicating that the package requires care in handling is selected using the input device 21a.

The delivery package 2 is then weighed (step S23). If the package exceeds a specific weight, this information is stored (as additional information 6B).

The delivery information 3A and 3B defined as described above is then printed to the surface of the label material 10 by the color printer 23 (step S24).

In this example the delivery information 3A containing the recipient information is printed in black in the first area 11 of the label material 10 as described above, and a specific bar code (delivery information 3B) is printed in black in the second area 12 of the label material 10.

Next, the additional information 6A, 6B defined as described above is printed to the surface of label material 10 by the color printer 23 (step S25).

To print a label as shown in FIG. 3, an indication (additional information 6A) that delivery package 2 requires care in handling is printed in a color other than black in the third area 13 of label material 10, and a symbol (additional information 6B) indicating that delivery package 2 weighs more than a specific weight is printed in multiple colors.

The distribution label 1C containing the delivery information 3A and 3B and additional information 6A, 6B is then applied to the delivery package 2 (step S26).

The delivery package 2 with attached distribution label 1C is then passed to the normal delivery channel and delivered.

By using a distribution label 1A to 1C according to an embodiment of the invention, where such label contains, in addition to delivery information 3A and 3B, other additional information 4, 5A, 5B, 6A, and/or 6B about the content of the delivery package 2, information about the delivery services (such as the delivery time and date of the package 2), and handling instructions for the delivery package 2, it is not necessary to apply multiple labels to, or specially wrap, the delivery package 2. Label application is therefore easier, the label printing system is simplified, and the cost of the labels, as well as problems with managing the labels, are reduced.

Furthermore, because the additional information 4, 5A, 5B, 6A, 6B containing handling and other delivery instructions is printed on the same label as the delivery information 3A and 3B, inadvertent human errors such as forgetting to apply a certain special label are reduced.

Furthermore, because the additional information 4, 5A, 5B, 6A, 6B is printed on demand in response to the sender's request, the need for inventory management of multiple different labels is eliminated and labels are not wasted when the label format is changed.

Furthermore, because the additional information 4, 5A, 5B, 6A, 6B of the distribution labels 1A to 1C applied to the delivery package 2 contains color information, the information is easier to read and recognize on the delivery route, thereby reducing delivery errors and thus shortening delivery time.

It will also be noted that the present invention is not limited to the embodiments described above but can be varied in many ways.

For example, the above embodiment is described selecting the additional information based on data tables 22b, 22c stored in the ROM of data processing unit 22. It is alternatively possible to select the additional information based on information accessed over a network including the Internet.

Furthermore, the additional information described above can be combined and printed in various ways as desired, and other types of delivery information and additional information can be printed in addition to the information described above. This also reduces inadvertent human errors such as forgetting to apply a certain special label for such other information.

The layout of the delivery information and additional information printed to the distribution label can also be varied as needed.

The present invention as described above also enables improving service to the customer (recipient). By using a distribution label 1A as shown in FIG. 1 on which the package content is indicated, the recipient can readily visually confirm information that can be difficult to concisely indicate with text, such as the shape, design, and color of the package content. This is beneficial in simplifying inventory management. Furthermore, using the distribution labels 1B shown in FIG. 2 the recipient can be informed using color and designs that the package is special (e.g., that it is a gift), thereby improving customer satisfaction.

Yet further, because the additional information 4, 5 is printed on demand in response to customer requests with the embodiments described above, delivery and distribution companies do not need to maintain stocks of numerous different kinds of labels according to the various services offered. This eliminates the need for inventory management of numerous types of labels, and eliminates wasted labels when the label format is changed.

The present invention thus enables building a distribution system that is low cost and simple yet fast and relatively error-free, and that can improve customer satisfaction.

While the invention has been described in connection with several specific embodiments with reference to the accompanying drawings, many further alternatives, modifications, variations and applications will be apparent to those skilled in the art that in light of the foregoing description. Thus, the invention described herein is intended to embrace all such alternatives, modifications, variations and applications as may fall within the spirit and scope of the appended claims.

What is claimed is:

1. A distribution label for application to a delivery package, comprising:
a printable surface defined by a plurality of areas, including
a first area having printed therein delivery information about an associated delivery package; and
a second area having printed therein additional information relating to an associated delivery package, wherein the additional information comprises, at least in part, a color representation identifying at least one of:
content of an associated delivery package,
delivery service information of an associated delivery package,
type of delivery package, or
handling information relating to an associated delivery package or contents therein.

2. The distribution label as described in claim 1, wherein the delivery service information includes a delivery date or time for an associated delivery package, delivery means instruction, or delivery priority instruction.

3. The distribution label as described in claim 1, wherein the type of delivery package includes information relating to a specific service for an associated delivery package.

4. A distribution label printing system for printing information on a distribution label, comprising:
an input unit for inputting data relating to an associated delivery package;
a data processing unit for generating delivery information and additional information relating to an associated delivery package based on the input data; and
a color printer for printing the generated delivery information and additional information to a surface of a distribution label, wherein the surface is defined by a plurality of areas, including
a first area having printed therein delivery information about an associated delivery package, and
a second area having printed therein additional information relating to an associated delivery package, wherein the additional information comprises, at least in part, a color representation identifying at least one of:
content of an associated delivery package,
delivery service information of an associated delivery package,
type of delivery package, or
handling information relating to an associated delivery package or contents therein.

5. A distribution method using a distribution label, comprising the steps of:
adding delivery information about an associated delivery package to a first area of the distribution label;
adding additional information relating to an associated delivery package to a second area of the distribution label, wherein the additional information comprises, at least in part, a color representation identifying at least one of:
content of the associated delivery package,
delivery service information of the associated delivery package,
type of delivery package, or
handling information relating to the associated delivery package or contents therein; and
applying the distribution label containing the delivery information and additional information to the associated delivery package.

6. The distribution method as described in claim 5, wherein the content, delivery service information, type, and handling information of the associated delivery package is selected from a specific table.

7. The distribution method as described in claim 5, wherein the delivery service information includes user-specified information relating to a delivery date or time, delivery means instruction, or delivery priority instruction.

8. The distribution method as described in claim 5, wherein the handling information includes information relating to handling instructions specified based on an attribute of the associated delivery package.

9. The distribution method as described in claim 5, wherein the type of delivery package includes information relating to a specific service for the associated delivery package.

10. The label as described in claim 1, wherein the plurality of areas of the printable surface further includes a third area having printed therein a bar code.

11. The label distribution printing system as described in claim 4, wherein the plurality of areas of the surface to which the color printer prints further includes a third area having printed therein a bar code.

12. The distribution method as described in claim 5, further comprising the step of adding a bar code to a third area of the distribution label.
